(19) United States
(12) Patent Application Publication
(10) Pub. No.: US 2007/0034650 A1
(43) Pub. Date: Feb. 15, 2007

(54) Fluid dispenser useful as a tissue roll dispenser

(75) Inventors: Paul Guenther Pulch, Kelkheim (DE); Sabine Unnasch, Kelkheim (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/498,442

(22) Filed: Aug. 3, 2006

(30) Foreign Application Priority Data
Aug. 1, 2005 (EP) 05016662.8

(51) Int. Cl. B67D 1/07

(52) U.S. Cl. 222/192; 242/597.5

(57) ABSTRACT

A fluid dispenser being useful as a tissue roll dispenser. The dispenser comprises a dispensing head, a base and a hollow body serving as a reservoir that is detachable from the base such as to release the distal closed end of the hollow body and to allow the insertion of the distal closed end into the axial void space of a tissue roll. The dispenser of the invention can prevent the tissue to be contaminated by any fluid during the placement of the tissue roll.

### FIELD OF THE INVENTION

This invention relates to the field of apparatus for dispensing fluids and tissues. In some aspects it also relates to the field of dispensing, holding and recharging kitchen towel rolls in a manner that also allows convenient dispensing of a cleaning fluid.

### BACKGROUND OF THE INVENTION

Fluid dispensers are well known and can be provided in a variety of forms and shapes. In the field of home care, fluid cleaners are in most instances dispensed from spray bottles. The spray bottles can include a spray head, a pump, a reservoir formed by the hollow body of the bottle and a dispensing nozzle. The fluid is moved by the action of the pump from the reservoir through the spray head and expelled from the spray nozzle. In most conventional dispensers, the pump is manually operated by the user.

Dispensers for tissue, especially rolled tissue, are known and used in many households. Most common dispensers are dispensers for toilet paper rolls that are affixed to a wall. Other dispensers especially those for kitchen towel rolls are provided as stand alone vertical dispensers onto which a roll of kitchen towels is inserted.

There are occasions where the user would benefit from having in a convenient proximity both a cleaning fluid dispenser and a dispenser for tissue rolls. Cleaning hard surfaces, e.g. windows, in a household is such an occasion where both a cleaning fluid and cleaning towels are needed in a repetitive way. Such house cleaning tasks furthermore require the cleaning devices, the cleaning fluid and the cleaning towels to be moved from place to place in a convenient way.

Combined dispensers have been described as apparatuses intended to dispense both a cleaning fluid and paper towels. Such dispensers are for example described in patent U.S. Pat. No. 6,644,563B2 issued to Kirk Preston. Some combined dispensers are also commercially available such as those sold by Spraybottles Inc, St Cloud, Fla., USA, under the name “Spray 'N Towel” and those sold by Hobby Club USA, 10771 Monte Vista, Ontario, Calif. 91762, USA, under the name “Spray Mate”.

These dispensers allow a roll of tissue to be inserted around an extension, which extension is also a part of an axial reservoir for cleaning fluid. The upper (proximal) part of the reservoir engages to a dispensing head connected to a pump comprised therein. A tube extends from the pump to the bottom (distal end) of the reservoir. It allows the fluid present at the bottom of the reservoir, for example when the reservoir is almost empty, to be efficiently pumped. The reservoir further comprises a hollow lower part that is of larger diameter than the axial part and forms a base for the dispenser. Refilling of the cleaning fluid is achieved by removing the dispensing head from the reservoir and filling the reservoir through its orifice. The recharging of the dispenser with a new tissue roll is operated in a similar way by removing the dispensing head and inserting a new roll around the axial reservoir.

The speed of consumption of the fluid is typically different from the speed of consumption of the tissue roll. Hence the fluid and the tissue roll need to be replaced at a different frequency. In conventional dispensers, it is however difficult, if not impossible, to remove and replace the dispensing head having the tube connected thereto without spoiling the tissue roll being inserted. Indeed, some cleaning fluid is often present in the dispensing head and/or in the tube. It can drip on the new tissue roll being placed resulting in inconvenience for the user and in a waste of tissue.

Another problem arises out of the variety of position from which the fluid is to be dispensed: The dispenser is intended to be held by the user with one hand while the fluid is being dispensed. The user usually needs to take a variety of positions in order to achieve efficiently his or her cleaning job. As the conventional dispensers have a wide base, it can be difficult to obtain an efficient dispensing, especially when the fluid is at low level in the reservoir, as the tube may not be in contact with the remaining fluid at the bottom of the reservoir in all positions.

There is a need for a dispenser dispensing both a fluid and a tissue roll that allows the tissue roll to be replaced without being contaminated by the fluid.

There is also a need for such a dispenser that can dispense a fluid in all positions and regardless the level of fluid in the dispenser, and which dispensing is not hindered by the movements of the user when using the dispenser.

### SUMMARY OF THE INVENTION

The invention relates to a fluid dispenser also useful as a tissue roll dispenser for tissue roll having an axial void space, comprising a dispensing head, a base and a hollow body. The dispensing head comprises a pump. The pump is configured to pump a fluid via a tube out of the hollow body and to dispense it through the dispensing head.

The hollow body has a proximal end a distal closed end and comprises a longitudinal dimension and perpendicular thereto a maximum cross section dimension. The proximal end is connected to the dispensing head. The hollow body is selected to at least partially fit inside the axial void space of a tissue roll such as to enable the rotation of the tissue roll around the hollow body.

The base is disposed at the distal closed end of the hollow body and provides a substantially stable stand for the fluid dispenser.

The dispenser of the invention is characterized in that the hollow body is detachable from the base such as to release the distal closed end and to allow the insertion of the distal closed end into the axial void space of a tissue roll.

As the distal closed end of the hollow body can be inserted into the axial void space of a tissue roll, there is no need to remove the dispensing head from the hollow body to recharge the dispenser with a new roll. The dispenser of the invention prevents the tissue from being contaminated by the fluid during the placement of the tissue roll.

In certain preferred embodiments, the distal closed end of the hollow body has a relatively narrow cross section dimension, not exceeding the diameter of the axial void space of a corresponding tissue roll. With such a narrow dimension of the distal end of the hollow body, the tube is kept in contact with the fluid over a variety of positions and regardless the level of fluid in the hollow body. This facilitates the use of the dispenser in all positions, even at low fluid level, and brings convenience and dispensing efficiency.

### BRIEF DESCRIPTION OF THE DRAWINGS

FIG. 1 is a perspective view of a dispenser of the invention with a tissue roll in place.

FIG. 2 is a perspective view of one embodiment of a dispenser of the invention.

FIG. 3 is a perspective view of one embodiment of the hollow body of a dispenser of the invention with the dispensing head connected thereto.

FIG. 4 is a perspective view of the dispensing head of a dispenser of the invention with the tube of the pump connected thereto.

FIG. 5 is a perspective view of the hollow body of a dispenser of the invention.

FIG. 6 is a perspective view of the base of a dispenser of the invention.

FIG. 7 is a perspective view of a dispenser of the invention

FIG. 8 is a perspective view of the base of the dispenser of FIG. 7 with a tissue roll in place and with both the hollow body and the dispensing head detached.

### DETAILED DESCRIPTION OF THE INVENTION

Definitions

For the purpose of the present invention, the following terms are given the meaning provided hereunder.

A “dispenser” is an apparatus intended to facilitate the accessibility to and the use of consumable items. In regard to the invention such consumable items can include fluids (“fluid dispensers”), or tissues (“tissue dispenser”). Conventional dispensers can provide a way to dose and/or dispense the consumable item in a convenient way. For example, a fluid dispenser dispenses a predetermined amount of fluid at each stroke of the trigger of a pump connected to or integrated into the dispenser. Similarly, a tissue roll dispenser may facilitate the separation of individual tissue sheets from the tissue roll typically along perforations provided in the tissue. Tissue dispensers are also tissue roll holders.

“Tissue” is substantially flat and made of a substantially absorbing material. In regard to the invention, tissues can include cellulosic substrates such as those used in paper towels, paper handkerchiefs, kitchen towels, toilet papers and the like. Tissues can also comprise non cellulosic material such as polypropylene and/or polyethylene fibers, and/or starch or starch derivatives and/or cellulose-derived materials such as viscose or Lyocell fibers. Examples of tissue articles comprising such non cellulosic materials include all sort of wiping articles such as baby, kids or adults wipes, hard surface cleaning wipes, cosmetic wipes or wipes intended to deposit an active on the wiped surfaces. Mixtures of cellulosic and non-cellulosic fibers are contemplated in the tissues of the invention. In regard to the invention, the tissues are provided in a rolled form. Conventionally tissue rolls have an axial void space, centrally located and delimited by a core. Typically cores are made of cardboard material. The tissue is rolled around the core. Some tissue rolls do not have a core but simply present a central void space. When the tissue roll is used with a dispenser, the axial void space is conventionally used to insert a part of the dispenser serving as axis for unrolling the tissue roll.

A “pump” is a device able to move a fluid from a reservoir. Pumps can be, for example, mechanical or electromechanical. Conventional pumps used in combination with fluid dispensers can include a piston moved by a trigger and a couple of valves. Other pumps use a plunger. The pump is conventionally comprised by, housed into or connected to a dispensing head. A tube extending from the dispensing head allows for the suction of the fluid from the reservoir while a nozzle enables the ejection of the fluid from the dispenser. The tube is in fluid communication with the fluid in the reservoir to allow the pumping action. The specificity of the nozzle and of the pump induces the type of fluid expulsion (e.g. spray, single jet, multiple jets).

The term “base” is to be understood as a device able to provide a substantially stable stand. A stable stand can be vertical, horizontal or angled depending on the specificities of the base and the intended use. A base can include a housing for the tissue roll and/or means of facilitating the separation of the sheets of tissue, and/or means for keeping the tissue roll in place (e.g. a clip). The base usually provides a substantially stable position for the dispenser when it is put on a relatively flat surface.

Dispenser of the Invention:

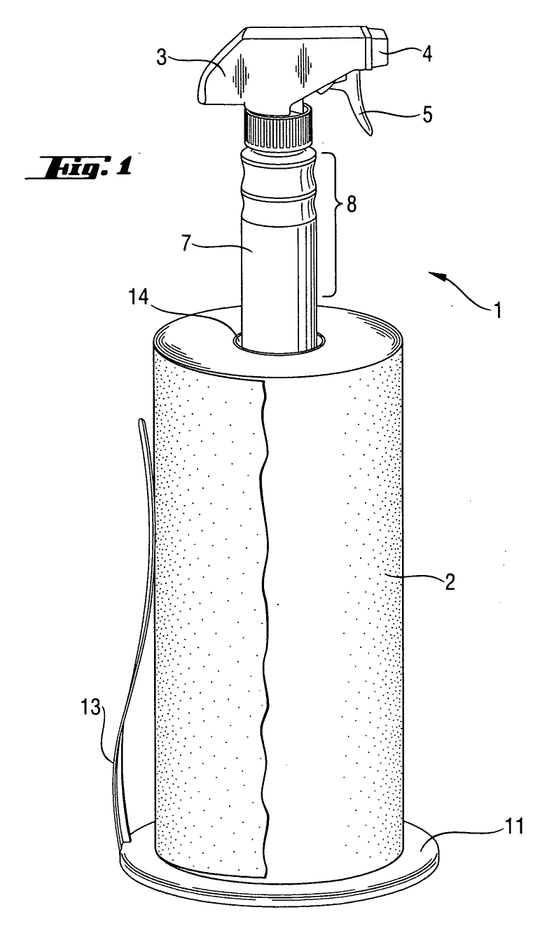

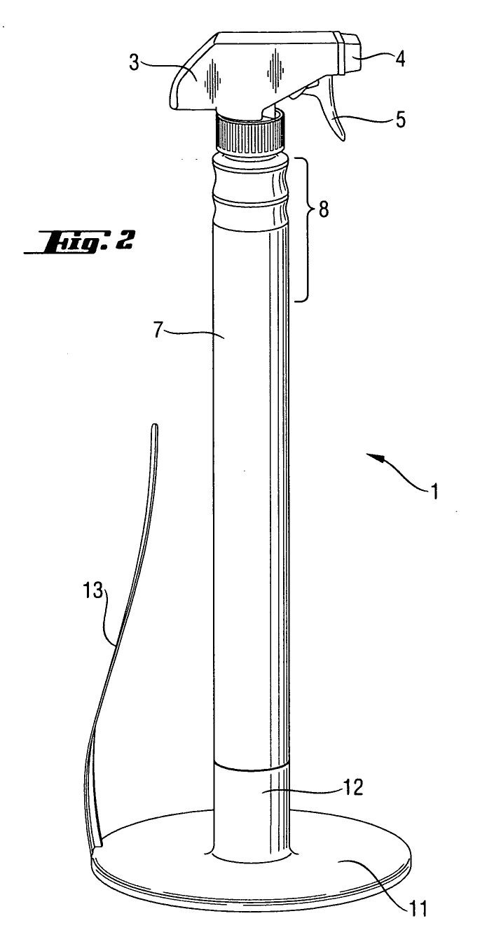

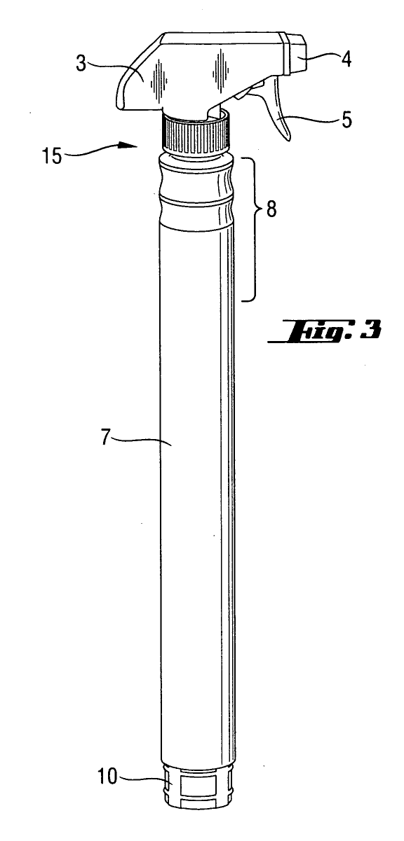

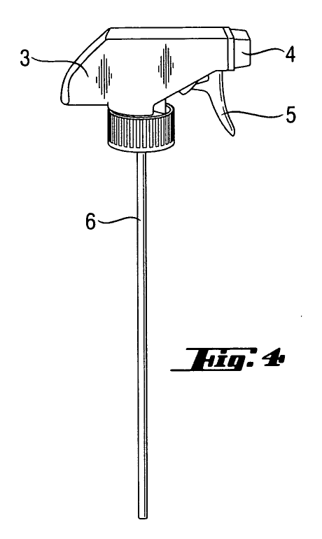

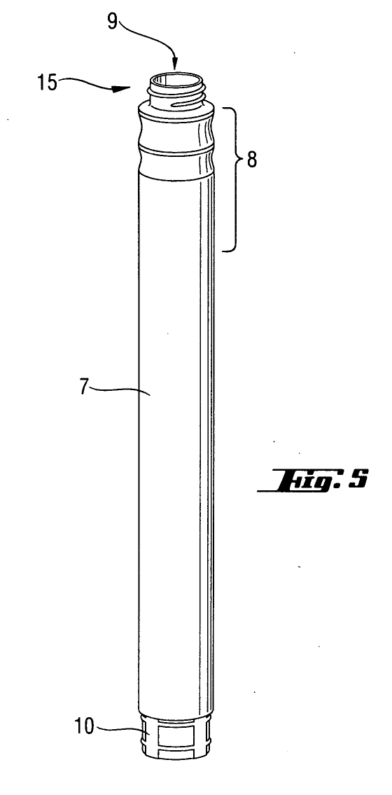

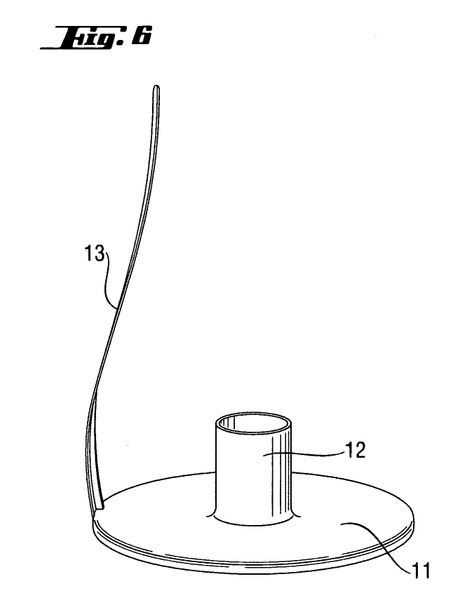

A dispenser (1) of the invention is shown on FIG. 1 in combination with a tissue roll (2) inserted thereunto. The dispenser of the invention is a fluid dispenser that is also useful as a tissue roll dispenser. The dispenser (1) of the invention comprises a dispensing head (3), a hollow body (7) and a base (11). FIG. 2 shows a similar dispenser of the invention without the tissue roll. The various parts of the dispenser are shown on FIGS. 3, 4, 5 and 6. The dispenser (1) of the invention and its operation are described below. Other embodiments can however diverge from the dispenser (1) shown in the Figures.

Dispensing Head and Pump:

The dispensing head (3) comprises a pump (not shown in the figures) connected to a trigger (5). The pump can be fully housed in the dispensing head (3). The action of the pump is to move fluid from a reservoir within the hollow body (7) and to discharge it from a nozzle (4) disposed on the dispensing head (3). The pump is connected to a tube (6) that conventionally extends to the bottom of the hollow body (7) serving as the fluid reservoir. The tube (6) allows moving the fluid up from the bottom of the hollow body (7) serving as fluid reservoir. A dispensing nozzle (4) disposed on the dispensing head (3) is connected to the pump to discharge the fluid from the dispenser (1). The dispensing head (3) is detachably connected to the hollow body (7), for example by threaded extension on the dispensing head (3).

Hollow Body—Reservoir

The hollow body (7) serves as a reservoir for the fluid. The hollow body (7) can be only partially hollow and the reservoir can be formed by a region of the hollow body (7) or by its entirety. The hollow body (7) has a proximal end (15) and a distal closed end (10). The proximal end (15) has an orifice (9). The proximal end (15) can be attached to the dispensing head (3), for example via a corresponding threaded extension. Detaching the hollow body (7) from the dispensing head (3) frees the hollow body orifice (9) and enables to refill the hollow body (7) with the intended fluid. The distal closed end (10) is opposite to the proximal end (15) and in some embodiments forms the bottom of the hollow body (7).

In certain embodiments, the hollow body (7) has general shape and dimension that is relatively long and narrow, such as to fit at least partially in the axial void space (14) of a tissue roll such as a conventional towel tissue roll, a toilet paper roll, a napkin roll, a roll of cleaning wipe, a roll of cosmetic wipes.

The hollow body (7) comprises a longitudinal dimension and a perpendicular maximum cross section dimension. In case the hollow body (7) does not have a uniform shape along its longitudinal dimension, the maximum cross section dimension is measured at the widest part of the region of the hollow body (7) intended to be inserted into the axial void space (14) of a tissue roll. It is to be understood that the hollow body can have multiple regions having various cross sections. The only region to be considered as for the “maximum cross section” is the region that can be inserted into the axial void space (14) of a tissue roll as the dimension of this region is linked to the substantially free rotation of the tissue roll around its axis. Other regions of the hollow body (7) can have wider or narrower cross sections without impairing the rotation of the tissue roll. In some embodiments of the invention it is contemplated to provide the hollow body (7) with a region of a relatively wide cross section in a region close to the proximal end (15) in order to provide a relatively larger volume of the reservoir versus a hollow body of substantially uniform cross section. In this embodiment (not shown in the figures), the hollow body (7) inserts into the axial void space (14) up to, but not including, the region of relatively wide cross section close to the proximal end (15). In one embodiment the width of the relative wide region is about the same as the diameter of a full tissue roll. The length of the hollow body (7) is measured along its longitudinal dimension from the proximal end (15) to the distal closed end (10), is generally greater than the maximum cross section dimension.

The maximum cross section dimension and the longitudinal dimension may be selected to allow the substantially free rotation of the tissue roll (2) around the hollow body (7). If the hollow body (7) is substantially cylindrical (as shown on FIGS. 1-5), the maximum cross section dimension is the maximum diameter of the cylinder. If the hollow body (7) has a different shape (e.g. parallelepipedic shape or ovoid-section), the maximum cross section dimension is the corresponding diagonal or width. Embodiments according to the invention are contemplated having a length of the hollow body (7) greater than 80 mm, greater than 100 mm, greater than 150 mm, greater than 200 mm, greater than 250 mm, greater than 330 mm or greater than 400 mm. In some embodiments of the invention the maximum cross section dimension is less than 60 mm, less than 50 mm, less than 40 mm, less than 35 mm or less than 20 mm. In one embodiment the hollow body is substantially cylindrical with a maximum cross section dimension of less than 60 mm. In other preferred embodiments the hollow body is substantially cylindrical with a maximum cross section dimension (i.e. diameter) of between 20 mm and 35 mm and a length between 250 mm and 400 mm.

Hand Grip

The hollow body (7) can comprise or be connected to a part configured to fit the hand of the user in a position permitting to hold the dispenser and to action the pump, optionally via a trigger (5) extending from the dispensing head (3). The part can comprise a hand grip (8). The user usually holds the dispenser at its hand grip (8) and/or at the dispensing head (3). The hand grip (8) can be integral to the hollow body (7) such as a simple extension or a region of the hollow body (7). The hand grip may be any suitable size, but typically, should fit the average size of a human hand, as shown for example in FIG. 1. Alternatively, the hand grip (8) can be a separate part disposed close to the hollow body (7) and connected to the dispenser (1) (embodiment not shown). Ribs, structures and gripping aids can be provided at the surface of the hand grip (8) to facilitate the holding. Such ribs are illustrated for example on FIG. 3 as the structures on the distal closed end (10) of the hollow body (7). Having his/her hand on the hand grip (8), the user can easily hold the dispenser and action the trigger (5) to expel fluid and perform the desired task in a convenient way. In certain embodiments of the invention the hand grip (8) is an integral part of the hollow body and has a dimension along the longitudinal dimension of the hollow body selected to be more than 50 mm, more than 80 mm or more than 100 mm, corresponding to the usual size (width) of human hands, and thus enabling the convenient placement of the user's hand. In these embodiments the dimension of the hand grip is measured from the proximal edge of the tissue roll (i.e. the edge of the tissue roll closest to the dispensing head) to the edge of the dispensing head (i.e. the closest edge of the dispensing head bordering the extremity of the hand grip) but excluding the trigger (5).

Base

A base (11) is disposed at the distal closed end (10) of the hollow body (7). The hollow body (7) is detachably connected to the base (11). In one embodiment the base (11) has an extension (12). The distal closed end (10) of the hollow body (7) can engage the extension (12) of the base (11).

The detachable connection between the hollow body (7) and the base (11) or its extension (12) can be a simple male/female insertion. The hollow body (7) (male) can simply engage into a preformed receptacle (female) of the base (11) or of the extension (12). Alternatively, a male protrusion on the base (11) or on its extension (12) can engage into a female receptacle on the hollow body (7) (embodiment not shown). The hollow body (7) and/or the base (11) and/or the extension (12) can have connecting members enhancing the detachable connection. Such connecting members can include, for example, frictional ribs or dents. The elasticity of the materials and the friction between them can be sufficient to hold the dispenser integral during use while a directed pulling action can induce the detachment of the hollow body (7) from the base (11) when desired. Alternatively, the connection can be facilitated by threaded male and female members on the hollow body (7), and/or the base (11) and/or the extension (12). Other connecting members are envisioned such as hooks or protrusions engaging into slits or holes and magnetic members.

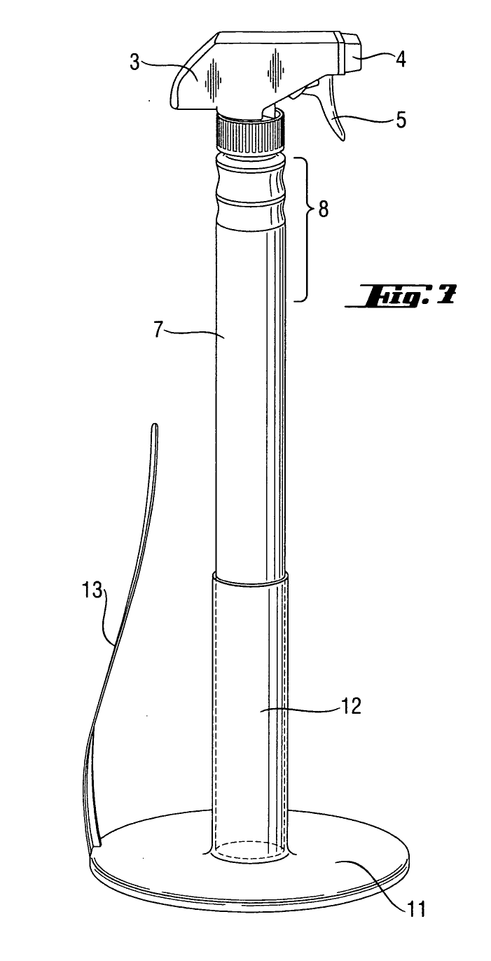

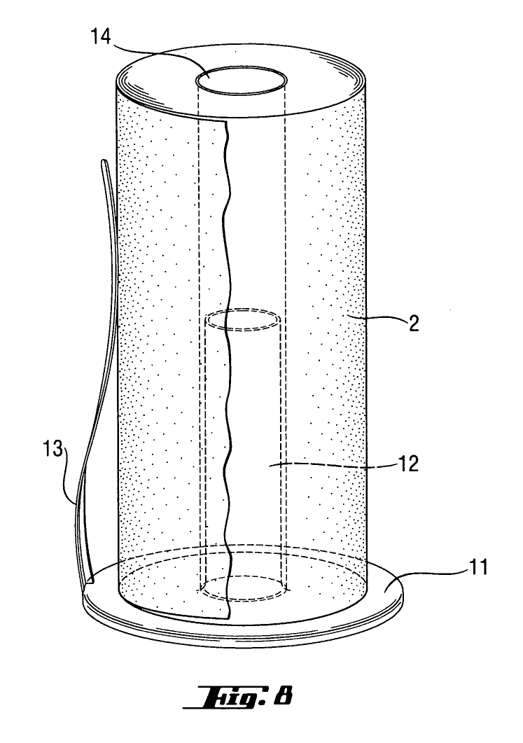

In an embodiment of the dispenser of the invention shown in FIGS. 7 and 8, the base (11) has an extension (12) that is long and narrow enough to significantly engage itself in the axial void space (14) of a tissue roll (2) (shown on FIG. 8) and to maintain the roll (2) in an upright position. In this way, the base of the dispenser of the invention can be used as a stand alone dispenser when the hollow body (7) (and hence the dispensing head) is detached from the base (11). The hollow body (7) can engage deeply into the extension (12) to provide a relatively larger reservoir (see FIG. 7). Alternatively, the hollow body (7) can have a short engagement into the extension (12).

The base (11) can have any shape and color selected for aesthetic or functional reasons. The base (11) may be, for example, circular with a diameter of more than 10 cm, more than 15 cm or more than 20 cm. The diameter of the base may be selected according to the diameter of the intended tissue roll (2) such as to provide adequate stability of the dispenser (1) when standing and insure proper protection of the tissue roll (2) from, for example, liquid or dust. Typically the base (11) has a diameter no more than 3 cm smaller than the diameter of the tissue roll (2), for stability reasons. The diameter of the base (11) can be substantially equal to the diameter of the roll (2).

Clip

The base (11) can comprise a clip (13) attached thereto or as an integral part thereof. The clip (13) is intended to maintain the tissue in place and avoid unintended unrolling during the storage, transportation and/or the use of the dispenser. Hence the clip (13) is configured to apply pressure onto the tissue roll (2). The clip (13) can be made of a material sufficiently hard and flexible to apply a pressure on the tissue roll (2). A substantially constant pressure may be desirable independent of the diameter of the tissue roll (2). This can be accomplished by the selection of the proper geometry, dimensions and material elasticity. This helps ensure the efficient functionality of the clip (13) whatever the degree of consumption of the roll (2) is (from a full roll to an almost empty roll). The clip (13) can also facilitate the separation of one or more sheets from the tissue roll (2), for example by having protrusions and/or dents initiating the tearing of the tissue sheets. The clip (13) can also be, for example, in the form of a bar applying pressure on the tissue over a wide area and/or it can comprise an elastic string or an elastic member or a spring.

Charging and Recharging the Dispenser with a Tissue Roll

For the placement of tissue roll (2) in the dispenser (1), the hollow body (7) is detached from the base (11) and a tissue roll is placed around the hollow body (7) by the insertion of the distal closed end (10) of the hollow body (7) into the axial void space (14) of a tissue roll (2). This provides for a simple and convenient way for recharging the dispenser (1) of the invention with tissue rolls (2). The dispensing head (3) need not to be separated from the hollow body (7). The tube (10), the inner part of the dispensing head (3) and the orifice (9) need not to be exposed. Only the distal closed end (10) of the hollow body (7) may come in contact with the roll being inserted, and not the proximal end (15). Hence the likelihood that some fluid will drip from the dispensing head (3) or from the tube (6) onto the inserted tissue roll (2) is decreased. This preserves the tissue from spoilage and prevents waste of tissue. As the reservoir of the hollow body (7) remains closed and the orifice (9) not exposed, the placement of the roll (2) can be made in all angled positions of the dispenser (1) and it is not necessary to maintain the hollow body (7) vertical during the placement of the tissue roll (2) to prevent spillage of liquid. This is an additional convenience for the user.

By construction, as the hollow body (7) at least partially inserts into the axial void space (14) of a tissue roll (2), the hollow body (7) has a relatively long and relatively narrow shape. This provides the additional benefit of dictating a relatively small cross section of the distal closed end (10). The dispenser of the invention can hence have a relatively high efficiency for dispensing fluid in respect to two aspects: (i) the dispenser can be used in a variety of angled positions with high efficiency (while still being able to allow pumping) and (ii) the dispenser can efficiently dispense fluid even when the fluid level is low in the hollow body (7).

Kit with Tissue Roll

A kit according to the invention comprises the dispenser (1) described above and a tissue roll (2) selected to fit and rotate around the hollow body (7) and optionally around the extension (12) of the base (11).

The maximum diameter of the tissue roll (2) may be limited by the position and/or the flexibility of the clip (13) if present. It is believed that the relation between the diameter of the roll (2) and the size of the base is important to provide an acceptable stability of the dispenser when standing. Preferably the diameter of the roll (2) (when new) is substantially less than 3 cm larger than a cross section of the base (11) for stability reasons. More preferably, the diameter of the roll (2) is substantially equal to the cross section of the base (11).

The axial void space (14) of the tissue roll of the kit of the invention can have a diameter of more than 20 mm, more than 30 mm, more than 40 mm, more than 50 mm or more than 80 mm. The axial void space (14) can be delimited by a core, for example made of cardboard, although rolls (2) without core can be contemplated to be both efficient and economical. It is understood that the diameter of the axial void space (14) will impact the volume of the hollow body (7). When large volumes are needed, it is advantageous to provide a tissue roll having a relatively large axial void space and a dispenser (1) with a correspondingly large maximum cross section of the hollow body (7).

The kit according to the invention can comprise an additional hollow body selected to fit the base (11) and the tissue roll (2). The additional hollow body can be provided with an additional dispensing head. The additional hollow body can detachably connect to the base (11) and can allow the substantially free rotation of the tissue roll (2) in a manner similar to the hollow body (7) of the kit. In a preferred embodiment, the hollow body (7) and the additional hollow body can have substantially the same dimensions. More preferably they have substantially identical shape and dimensions but the color and/or visual indicia on the additional hollow body is distinct from the color and/or visual indicia on the hollow body (7). The hollow body (7) and the additional hollow body can be provided with fluids. Preferably, the additional hollow body is provided with a fluid that is different from the fluid provided in the hollow body (7). Providing a kit with 2 hollow bodies (the hollow body (7) and the additional hollow body) enables the user to alternatively use the hollow body (7) and the additional hollow body in connection with the same base (11). The user can attach the desired hollow body to the base (11) to perform a desired task (for example cleaning window, with a hollow body provided with window cleaning fluid). For performing a subsequent or different task (for example treating or cleaning a wooden surface) the user detaches the hollow body (7) and attaches the additional hollow body (for example provided with cleaning fluid for wooden surfaces). The combination of the base (11) and a tissue roll (2) with a variety of hollow bodies provides a high degree of convenience to the user. A dispensing system is contemplated within the scope of this invention utilizing a base (11) with a number of hollow bodies (7) or additional hollow bodies. Each hollow body (7) or additional hollow body can be provided with a different fluid. In this system, the user selects a hollow body (7) (depending of the fluid enclosed therein and of the task to be performed), attaches the selected hollow body (7) or additional hollow body to the base (11) provided with a tissue roll (2) thereon, and performs the desired task. Using the same base (11) and the same tissue roll (2), the user detaches the hollow body (7) and attaches another hollow body (7) or additional hollow body to perform a different or subsequent task.

An embodiment of the kit of the invention comprises a fluid in the hollow body (7). Preferably the fluid is a cleaning fluid. More preferably the fluid is a cleaning fluid suitable for performing similar cleaning tasks as the cleaning tasks the tissue roll is suitable for. Even more preferably the cleaning tasks comprise windows cleaning. The fluid and the tissue roll can be both specifically designed for that specific cleaning task.

An embodiment of the kit of the invention comprises an additional fluid container. The additional fluid container comprises a fluid intended for use in the hollow body (7), preferably a cleaning fluid. The additional fluid container can serve as a reserve for fluid from which the fluid is refilled into the hollow body.

In one embodiment of the kit of the invention the fluid dispenser (1) and the tissue roll (2) comprise a matching indicia. The indicia can be in the form of a print or of a coating, or of an embossment or of any other form. The indicia can include—but is not limited to—an alphabetical character, a word, a number, an icon, a drawing, a color, a combination of colors, a pattern, a picture, a representation of an object or combination thereof. In one embodiment the indicia is a blue color, preferably in a repeated dot pattern. Matching indicia can be identical indicia or not identical indicia. They can be related indicia, by their pattern, color, shape, graphical appearance or meaning. They can be negative images of each other. Preferably the indicia or a part of it is present on the base (11) or the hollow body (7) of the fluid dispenser, or both.

In an embodiment of the kit of the invention the dispenser (1) comprises instructions to instruct how operate the dispenser. Preferably the instructions instruct how to detachably connect the hollow body to the base such as to release the distal closed end and to allow the insertion of the distal closed end into the axial void space of a tissue roll. Preferably said instructions comprise graphical or iconic instructions, alone or in combination with words. In one embodiment, the instructions are part of the matching indicia. In one embodiment the instruction are provided on the dispenser (1) or on the tissue roll (2) or on both. In one embodiment the instruction are provided on a separate medium.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fluid dispenser also being useful as a tissue roll dispenser for tissue rolls comprising an axial void space,
said fluid dispenser comprising a dispensing head, a base and a hollow body,
said dispensing head comprising a pump, said pump being configured to pump a fluid out of said hollow body and to dispense it through said dispensing head,
said hollow body serving as a reservoir for said fluid and said hollow body having a proximal end and a distal closed end and said hollow body having a longitudinal dimension and perpendicular thereto a maximum cross section dimension, said proximal end being connected to said dispensing head,
said hollow body being selected to at least partially fit inside the axial void space of a tissue roll such as to enable the rotation of said roll around said hollow body,
said base being disposed at the distal closed end of said hollow body and providing a substantially stable stand for said fluid dispenser, wherein
said hollow body is detachably connected to said base such as to release said distal closed end and to allow the insertion of said distal closed end into said axial void space of a tissue roll.

2. The fluid dispenser of claim 1 further comprising a clip configured to apply pressure onto said tissue roll such as to prevent the unintended unrolling of said tissue roll.

3. The fluid dispenser of claim 2, wherein said clip is integral to said base.

4. The fluid dispenser of claim 1 wherein said hollow body further comprises a part adjacent to said dispensing head, said part being configured to fit the hand of the user in a position permitting to hold said dispenser and to operate said pump.

5. The fluid dispenser of claim 4 wherein said part further comprises a dimension along said longitudinal dimension of said hollow body of more than 50 mm.

6. The fluid dispenser of claim 1 wherein said base further comprises an extension, said extension being selected to at least partially fit inside said axial void space of a tissue roll and to enable the rotation of said roll around said extension, such as to allow the use of said base as a stand alone rolled tissue dispenser when said dispensing head and hollow body are detached from said base.

7. The fluid dispenser of claim 1 wherein said hollow body is substantially cylindrical and has a maximum cross section dimension less than about 60 mm.

8. The fluid dispenser of claim 7 wherein said hollow body has a length along said longitudinal dimension of greater than about 80 mm.

9. A kit comprising the fluid dispenser of claim 1 and a tissue roll wherein said tissue roll fits and rotates around said hollow body.

10. The kit of claim 9 wherein said tissue roll fits and rotates around said extension of said base.

11. The kit of claim 9 wherein said tissue roll comprises a substantially cylindrical axial void space having diameter of more than about 30 mm.

12. The kit of claim 9 wherein said part has a dimension greater than about 80 mm, said dimension of said part being measured along the longitudinal dimension of said hollow body from the proximal edge of said tissue roll to the closest edge of said dispensing head.

13. The kit of claim 9 comprising an additional hollow body selected to fit said base and said tissue roll.

14. The kit of claim 9 further comprising a cleaning fluid in said hollow body.

15. The kit of claim 9 further comprising an additional fluid container wherein said additional fluid container comprises a fluid intended for use in said hollow body.

16. The kit of claim 9 wherein said fluid dispenser and said tissue roll comprise matching indicia.

17. The kit of claim 16 wherein said dispenser comprises instructions of how to detachably connect said hollow body to said base to release said distal closed end and to allow the insertion of said distal closed end into said axial void space of a tissue roll, said instructions comprising graphical or iconic instructions.
